(19) United States
(12) Patent Application Publication
(10) Pub. No.: US 2009/0261025 A1
(43) Pub. Date: Oct. 22, 2009

(54) FEED AND SORTING DEVICE FOR PACKAGING MACHINES

(76) Inventors: Kurt GNANN, Biberach (DE); Martin ZULEGER, Achstetten (DE)

Correspondence Address: BRINKS HOFER GILSON & LIONE, P.O. BOX 10395, CHICAGO, IL, 60610, US

(21) Appl. No.: 12/424,283

(22) Filed: Apr. 15, 2009

(30) Foreign Application Priority Data
Apr. 16, 2008 (EP) 08 007 415.6

(51) Int. Cl. B07B 13/00

(52) U.S. Cl. 209/657

(57) ABSTRACT

The feed and sorting device for tablets has a base unit, a plurality of vertically extending filling tubes each of them having a guiding channel for the tablets, and a blocking slide unit detachably mounted to the base unit. The blocking slide unit has a blocking slide plate which is movable back and forth by means of a drive arranged in the base unit and thus serves for temporarily blocking the guiding channels of the filling tubes. The drive is connected to a first magnetic coupling element which is engageable with a second magnetic coupling element arranged on the blocking slide plate so that the blocking slide plate is securely connected to the drive when the first or the second magnetic coupling element is activated.

### CROSS-REFERENCE TO RELATED APPLICATIONS

This application claims the benefit of European Patent Application No. EP 08 007 415.6 filed on Apr. 16, 2008, entitled “FEED AND SORTING DEVICE FOR PACKAGING MACHINES” the entire contents of which are incorporated herein by reference.

### FIELD OF THE INVENTION

The invention pertains to feed and sorting devices for tablets, capsules, dragées, or the like on packaging machines, especially on thermoforming machines.

In the case of feed and sorting devices for tablets, capsules, dragées or the like on packaging machines with a base unit and a blocking slide unit, which comprises a slide guide and a blocking slide plate which moves in the slide guide, it is advantageous for the blocking slide unit to be connected detachably to the base unit for maintenance or cleaning. In the case of conventional feed and sorting devices, this is accomplished by plungers attached to the base unit, wherein spring elements press the blocking slide plates onto the plungers. The advancing movement is produced by a single-acting pneumatic cylinder, which works against the spring elements and thus puts them under tension. The return stroke takes place exclusively by means of the spring elements. In the case of conventional feed and sorting devices, spring elements are attached on both sides of the blocking slide unit to ensure a uniform stroke.

When the conventional feed and sorting devices are disassembled for cleaning and/or maintenance, the blocking slide unit with its blocking slide plate must be removed. To prevent the plate from being pushed unintentionally out of the lateral guides by the force of the springs, a locking device is required. When this locking device is released, the blocking slide plate can be removed, wherein care must be taken to ensure that, during this removal process, the spring elements, which are now loose, do not become lost.

The conventional feed and sorting devices also suffer from the disadvantage that, because of the many small mechanical parts required for the transmission of movement from the base unit to the blocking slide unit, these conventional feed and sorting devices are expensive to manufacture.

### SUMMARY OF THE INVENTION

It is an object of the present invention to provide a feed and sorting device for tablets, capsules, dragées or the like, which can be manufactured quickly and at low cost and which can also be disassembled easily. Further, an exact movement of the blocking slide plates should be ensured and the lifetime of the feed and sorting device prolonged.

According to an aspect of the invention, the feed and sorting device for tablets, capsules or dragées comprises: a base unit, a plurality of vertically extending filling tubes each of them having a guiding channel for tablets, capsules or dragées, and a blocking slide unit. The blocking slide unit is detachably mounted to the base unit and comprises a first blocking slide plate which is movable back and forth by means of a first drive arranged in the base unit and thus serves for temporarily blocking the guiding channels of the filling tubes. The first drive is connected to at least one first magnetic coupling element which is engageable with a second magnetic coupling element arranged on the first blocking slide plate so that the first blocking slide plate is securely connected to the first drive when the first or the second magnetic coupling element is activated.

Because of the small number of components, therefore, the feed and sorting device can be assembled and disassembled quickly. An additional advantage is that small mechanical components, which could easily be lost during assembly and disassembly for maintenance and/or cleaning, are avoided. Additional advantages are to be seen in the fact that light-weight components can be used.

In a first embodiment of the feed and sorting device, the first magnetic coupling elements are magnets arranged on the base unit, and the second magnetic coupling elements are magnetic couplers arranged on the blocking slide plate. This offers the advantage that the blocking slide plate can be produced at low cost and can be replaced on the base unit to satisfy the different requirements associated with different types of tablets.

In a second embodiment of the feed and sorting device, the second magnetic coupling elements are magnets, and the first magnetic coupling elements are magnetic couplers arranged on the base unit.

In a third embodiment of the feed and sorting device, which represents a combination of the first and second embodiments, magnets are arranged on the base unit and also on the blocking slide plate and magnetic couplers are also arranged on both the blocking slide plate and on the base unit.

It has been found to be advantageous for the blocking slide unit to comprise two blocking slide plates arranged one above the other, wherein the magnets and the couplers are arranged with an offset from each other in such a way that the blocking slide plates can be moved in opposite directions.

### BRIEF DESCRIPTION OF THE DRAWINGS

The invention is explained in greater detail below on the basis of exemplary embodiments, which are illustrated in the drawings.

FIG. 1a is a perspective view of a feed and sorting device;

FIG. 1b is a perspective view of the base unit and of the blocking slide unit of the feed and sorting device;

FIG. 2 is a perspective view of the base unit and of a format unit comprising the blocking slide unit and filling shoes;

FIG. 3 is an enlarged perspective view of the blocking slide unit with magnetic coupling;

FIG. 4 is a detailed perspective view of the arrangement of magnets, magnet mounts, and couplers for the magnetic coupling;

FIG. 5 is a schematic cross-sectional view of how the format unit is clamped to the base unit by means of pneumatic cylinders; and

FIG. 6 is a perspective view of the openings in the format unit for the engagement of the pneumatic cylinders.

### DETAILED DESCRIPTION OF SPECIFIC EMBODIMENTS

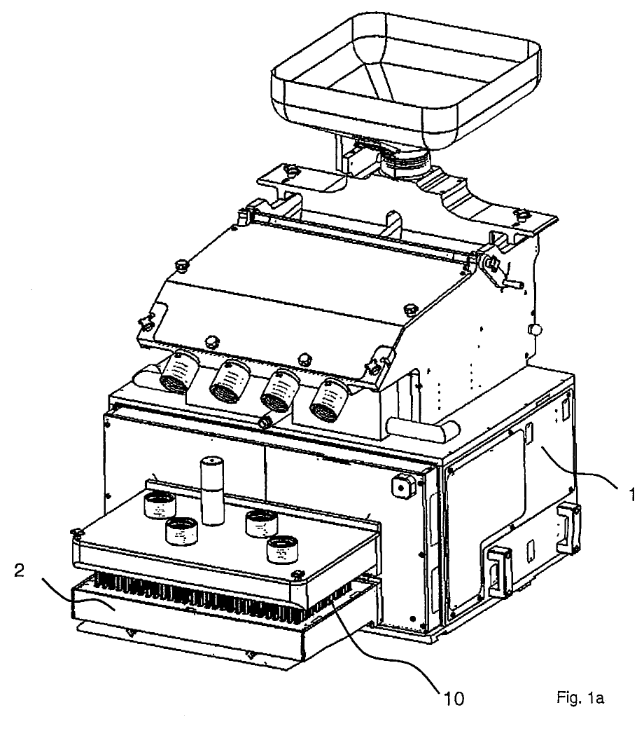

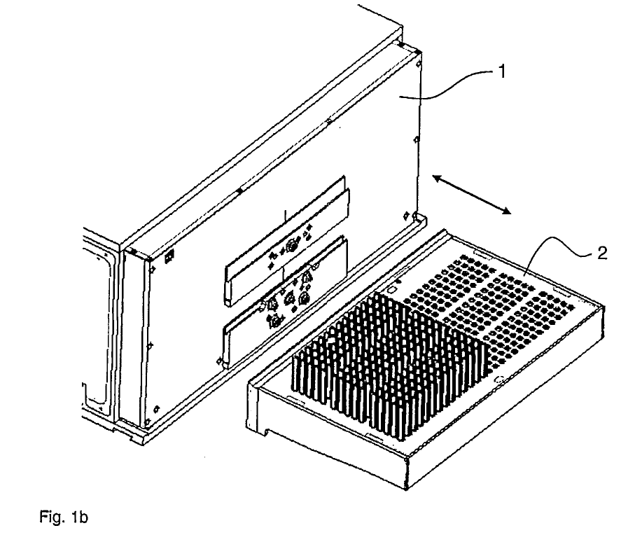

FIG. 1a is a perspective view of a feed and sorting device, and FIG. 1b is a perspective view of a base unit 1 and of a blocking slide unit 2 of the feed and sorting device of FIG. 1a in the disassembled state. The base unit 1 is stationary, whereas the blocking slide unit 2 can be selected and replaced depending on the requirements of the tablets, capsules, dragées or the like which are to be fed and sorted.

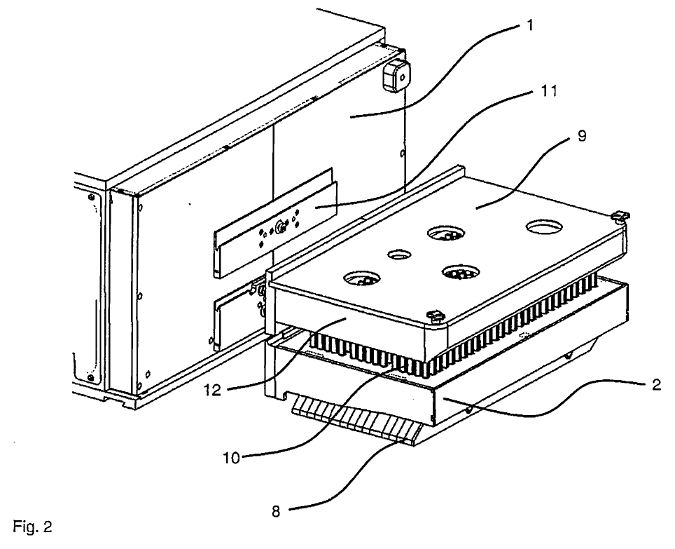

FIG. 2 is a perspective view of the base unit 1 and a format unit 9, which comprises the blocking slide unit 2, filling tubes 10, and filling shoes 8, wherein the format unit 9 also can be selected and replaced in a product-specific manner depending on the requirements of the tablets, capsules, dragées or the like which are to be fed and sorted. The base unit 1 comprises a hanger device 11 so that the format unit 9 can be removed from the base unit 1 without tools.

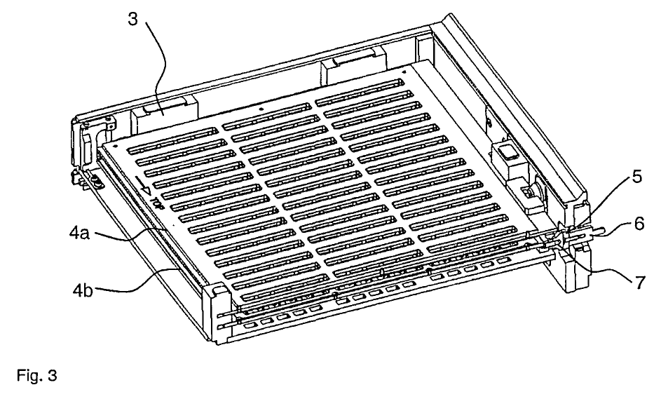

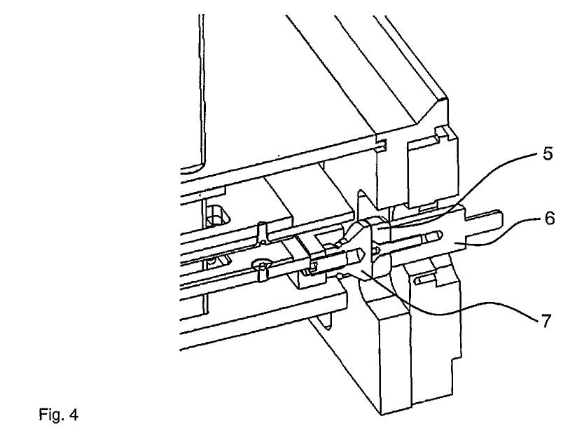

The tablets or the like to be fed and sorted are conducted from a loading hopper by way of a vibration unit onto a sorting plate 12 (which is covered in FIG. 2 and can thus not be seen in detail). There they are sorted into the filling tubes 10 by upward and downward movements of the sorting plate 12. The filling tubes 10 are designed to provide a proper orientation of the tablets. The tablets, which are arranged in a stack in the filling tubes 10, must further be singled out so that only individual tablets are fed to each pocket of a blister package. This separation process of single tablets in the filling tubes 10 is performed by the blocking slide plates 4a and 4b (FIGS. 3 and 4) of the blocking slide unit which are moved out of and back into the guiding channel of the filling tubes 10. In this way, the blocking slide plates 4a and 4b block the guiding channel in their inserted position, while they allow exactly one tablet per filling tube 10 to fall down in their removed position. Thus, the blocking slide plates 4a and 4b are moved back and forth in opposite directions to individuate the tablets. This movement is transmitted from at least one drive (not shown) in the base unit to the blocking slide plates 4a and 4b. The blocking slide plates 4a and 4b are guided in slide guides 3 and thus execute linear movement.

FIG. 3 shows an exemplary embodiment of the present invention. The blocking slide unit 2 shown comprises two blocking slide plates 4a, 4b arranged one above the other. The number of blocking slide plates 4a, 4b can be different.

FIG. 4 is an enlarged view of the exemplary embodiment of FIG. 3, in which a first magnetic coupling element 5, preferably a magnet for generating a magnetic field, in particular a permanent magnet or an electromagnet, is attached to a magnet mount 6 on the base unit 1, which is connected to the drive, whereas a second magnetic coupling element 7, preferably a magnetic coupler having a seat and a pin insertable into an opening formed in the magnet, is attached to the blocking slide plate 4a of the blocking slide unit 2. Usually, there is more than one first and second magnetic coupling element 5, 7 per blocking slide plate 4a.

This magnetic coupling can preferably be activated and deactivated. For example, when the feed and sorting device is to be changed over to a new tablet format, the old blocking slide unit 2 must be disconnected from the base unit and the new one attached to it. This can be done easily with the inventive structure when the magnetic coupling is deactivated.

Further, it may be possible to activate the magnetic coupling only during the backward movement of the blocking slide plate 4a in order to securely connect the blocking slide plate 4a to the drive and to ensure a proper movement of the blocking slide plate 4a when the drive is moving. During the forward movement of the blocking slide plate 4a, the magnetic coupling does not have to be activated since the first magnetic coupling element 5 mechanically engages with the second magnetic coupling element 7 and thus moves the blocking slide plate 4a.

Of course, it is also possible for the magnet to be the second magnetic coupling element 7 arranged on the blocking slide plate 4a and the magnetic coupler to be first magnetic coupling element 5 on the base unit 1. A number of other magnetic couplings are also conceivable.

Each blocking slide plate of the blocking slide unit 2 could be provided with at least one magnetic coupling element, and a corresponding magnetic coupling element could be provided in the base unit 1. For example, in the case of two blocking slide plates 4a, 4b, a third magnetic coupling element (not shown) could be arranged in the base unit 1 and a fourth magnetic coupling element (not shown) could be arranged on the second blocking slide plate 4b. The number of drives could be adapted accordingly. It is also possible that only one drive serves for moving all blocking slide plates 4a, 4b.

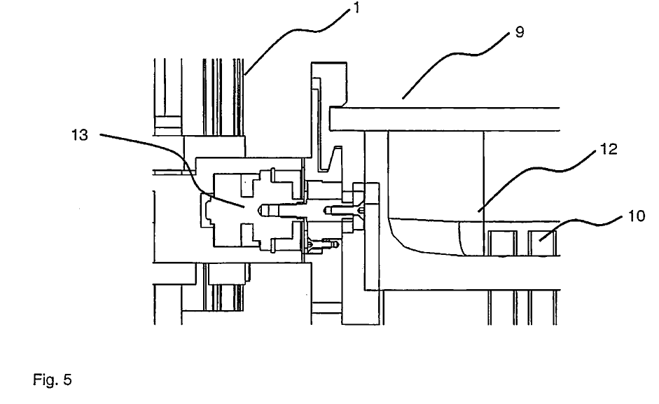

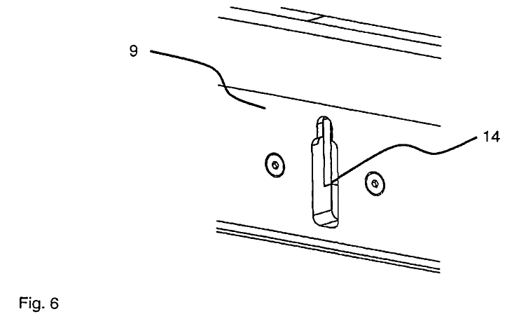

FIG. 5 shows that the format unit 9 is prevented from moving unintentionally relative to the base unit 1 during operation by a pneumatic cylinder 13, which clamps the format unit 9 to the hanger device 11 on the base unit 1. As shown in FIG. 6, an opening 14 is provided, into which the pneumatic cylinder 13 can engage.

1. A feed and sorting device for tablets, capsules or dragées comprising:
a base unit;
a plurality of vertically extending filling tubes each of them having a guiding channel for tablets, capsules or dragées; and
a blocking slide unit detachably mounted to the base unit, the blocking slide unit comprising a first blocking slide plate which is movable back and forth by means of a first drive arranged in the base unit and thus serves for temporarily blocking the guiding channels of the filling tubes;
wherein the first drive is connected to at least one first magnetic coupling element which is engageable with a second magnetic coupling element arranged on the first blocking slide plate so that the first blocking slide plate is securely connected to the first drive when the first or the second magnetic coupling element is activated.

2. The feed and sorting device according to claim 1, wherein the first magnetic coupling element is a magnet, and the second magnetic coupling element is a corresponding magnetic coupler.

3. The feed and sorting device according to claim 1, wherein the second magnetic coupling element is a magnet, and the first magnetic coupling element is a corresponding magnetic coupler.

4. The feed and sorting device according to claim 2 or 3, wherein the magnet is a permanent magnet.

5. The feed and sorting device according to claim 3, wherein the magnet is a permanent magnet.

6. The feed and sorting device according to claim 2, wherein the magnet is an electromagnet.

7. The feed and sorting device according to claim 3, wherein the magnet is an electromagnet.

8. The feed and sorting device according to claim 2, wherein the magnetic coupler has a seat and a pin insertable into an opening formed in the magnet.

9. The feed and sorting device according to claim 3, wherein the magnetic coupler has a seat and a pin insertable into an opening formed in the magnet.

10. The feed and sorting device according to claim 1, wherein the blocking slide unit comprises a second blocking slide plate arranged above or below the first blocking slide plate, wherein the base unit comprises a third magnetic coupling element engageable with a fourth magnetic coupling element arranged on the second blocking slide plate so that the second blocking slide plate is securely connected to a second drive in the base unit when the third or the fourth magnetic coupling element is activated.

11. The feed and sorting device according to claim 10, wherein the first and third magnetic coupling elements are arranged with an offset from each other.
